(19) United States
(12) Patent Application Publication
(10) Pub. No.: US 2009/0060609 A1
(43) Pub. Date: Mar. 5, 2009

(54) Medium feeding apparatus and image forming apparatus that employs the image feeding apparatus

(75) Inventor: Osamu Watanabe, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/230,378

(22) Filed: Aug. 28, 2008

(30) Foreign Application Priority Data
Aug. 31, 2007 (JP) 2007-225123

(51) Int. Cl. G03G 15/00

(52) U.S. Cl. 399/395

(57) ABSTRACT

A medium feeding apparatus feeds medium. A medium transporting mechanism transports a medium. A skew removing mechanism includes a first roller and a second roller in pressure contact with the first roller. An adjusting mechanism adjusts a degree of rotational axes of the first and second rollers being right angle at a direction in which the medium should be transported by the medium transporting mechanism.

### BACKGROUND OF THE INVENTION

1. Field of the Invention

The present invention relates to a medium feeding apparatus having registry rollers that are provided along a medium transporting path for removing the skew of a print medium.

2. Description of the Related Art

A conventional medium feeding apparatus includes a plurality of rollers. A hopping roller picks up the top sheet from a stack of print medium. The sheet is then pulled in between another roller and a retard roller. The retard roller retards the second sheet under the top sheet. A registry roller causes the sheet fed to halt and then advance further into an image forming section at predetermined timing.

When an image forming apparatus equipped with a conventional medium feeding apparatus is placed on a table or a floor not sufficiently horizontal due to distortion or warp, rollers along the transport path of the print medium in the apparatus do not lie in sufficiently horizontal planes. This may lead to skew of print medium in the apparatus. Mounting an additional medium tray(s) to the image forming apparatus increases a total number of components of the image forming apparatus. Therefore, it will be difficult to maintain medium-transporting rollers in substantially horizontal planes and parallel to one another if medium-transporting rollers of additional medium trays are somewhat inclined relative to the horizontal planes, the problem would be more serious. The result would be more serious.

### SUMMARY OF THE INVENTION

The present invention is intended to provide a medium feeding apparatus feeds medium without skew. A medium transporting mechanism transports a medium. A skew removing mechanism includes a first roller and a second roller in pressure contact with the first roller. An adjusting mechanism adjusts a degree of rotational axes of the first and second rollers being right angle at a direction in which the medium should be transported by the medium transporting mechanism.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates the general configuration of a printer of an image forming apparatus of a first embodiment;

FIG. 2 is a perspective view of a skew removing mechanism of an additional medium feeding unit shown in FIG. 1;

FIG. 3 is another perspective view of the skew removing mechanism as seen in a direction shown by arrow C of FIG. 2;

FIG. 4 is an expanded view of pertinent potions of the skew removing mechanism;

FIG. 5 is an expanded view of a pertinent portion of FIG. 3;

FIG. 6 is a perspective view of a portion shown in FIG. 4 looking in another direction;

FIG. 7 is an expanded view of pertinent potions of the skew removing mechanism;

FIG. 8 is a perspective view of a portion shown in FIG. 7 looking in another direction;

FIGS. 9-12 illustrate the rotational positions of a cam;

FIG. 13 illustrates a print medium and leading end of an image printed on the print medium when the pointer points to “0” and the axes of a registry roller and a pressure roller are parallel to the rotational axes of respective photoconductive drums;

FIG. 14 illustrates a skew adjusting print pattern when the print medium is skewed as shown in dotted lines in FIG. 13;

FIG. 15 illustrates the skew adjusting print pattern when the print medium is skewed as shown in dot-dashed lines in FIG. 13;

FIG. 16 illustrates an image forming apparatus that employs two additional medium feeding units;

FIG. 17 is a perspective view illustrating a skew removing mechanism of a second embodiment;

FIG. 18 is an expanded view illustrating a pertinent portion of FIG. 17;

FIG. 19 is an exploded perspective view illustrating a pertinent portion of a cam driving mechanism;

FIG. 20 is a block diagram illustrating a pertinent portion of a controller that controls the operation of an image forming apparatus of the second embodiment; and

FIGS. 21A-21C show the skew removing mechanism as seen in a direction shown by arrow B shown in FIG. 17.

### DETAILED DESCRIPTION OF THE INVENTION

### First Embodiment

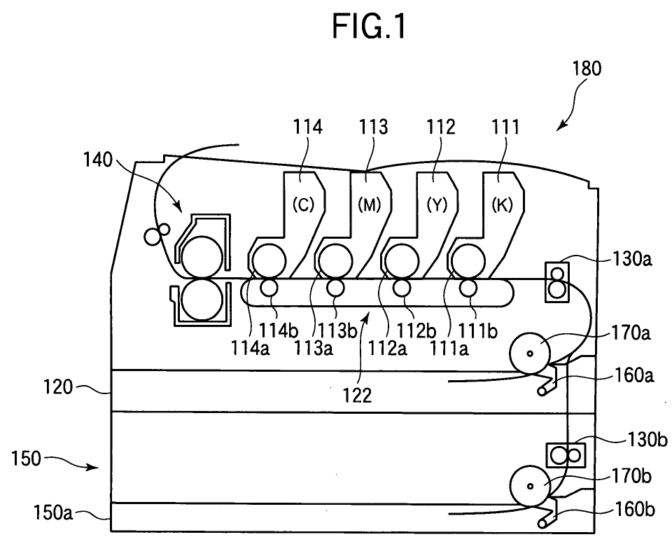

FIG. 1 illustrates the general configuration of an image forming apparatus 180 of a first embodiment.

Referring to FIG. 1, the image forming apparatus 180 is, for example, a tandem type electrophotographic color printer. A paper cassette 120 holds a stack of print medium therein. A feed roller 170a feeds the print medium to a transport path on a page-by-page basis. A separator pad 160a cooperates with the feed roller 170a to feed only the top sheet of the stack of print medium into the transport path. A skew removing mechanism 130a removes the skew of the print medium fed from the paper cassette 120. The feed roller 170a and separator pad 160a may be referred to as a medium advancing apparatus. The combination of the medium advancing apparatus and the skew removing mechanism 130a may be referred to as a medium feeding apparatus. Image forming sections 111, 112, 113, and 114 form black, yellow, magenta, and cyan toner images on photoconductive drums 111a, 112a, 113a, and 114a, respectively. A transfer belt unit 220 includes transfer rollers 111b, 112b, 113b, and 114b that extend parallel to the photoconductive drums 111a, 112a, 113a, and 114a, respectively, and that transfers the toner images of the respective colors onto the print medium fed by the skew removing mechanism 130a. A fixing device 140 fuses the toner images on the print medium by heat and pressure.

The image forming apparatus 180 may further include an additional medium feeding unit 150. The medium feeding unit 150 includes a paper cassette 150a, a feed roller 170b, a separator pad 160b, and a skew removing mechanism 130b. The paper cassette 150a holds a stack of print medium therein. The feed roller 170b feeds the print medium into the transport path from the paper cassette 150a on a page-by-page basis. The separator pad 160b cooperates with the feed roller 170b to feed only the top page of the stack of print medium into the transport path. The skew removing mechanism 130b removes the skew of the print medium fed from the paper cassette 150a.

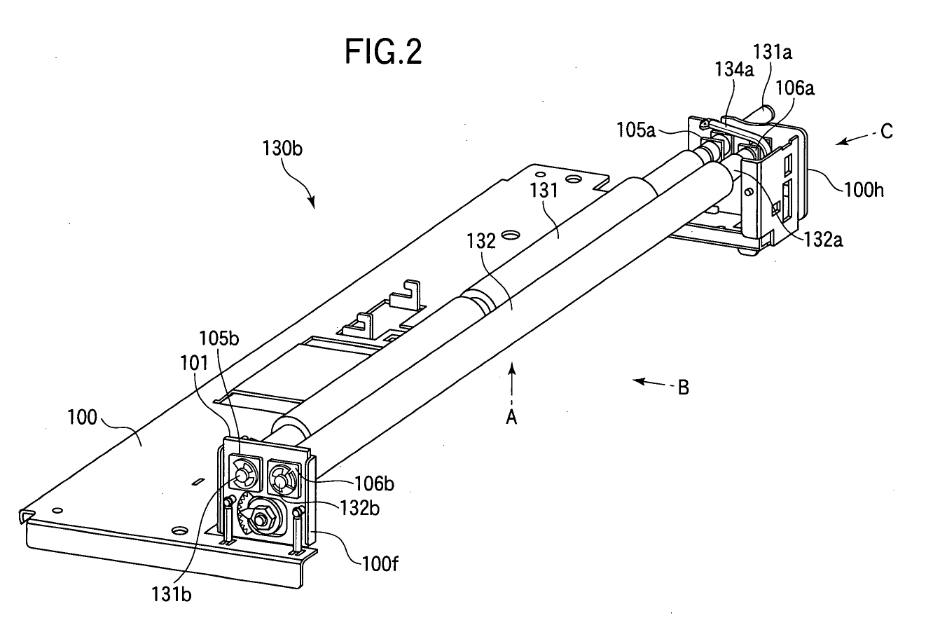

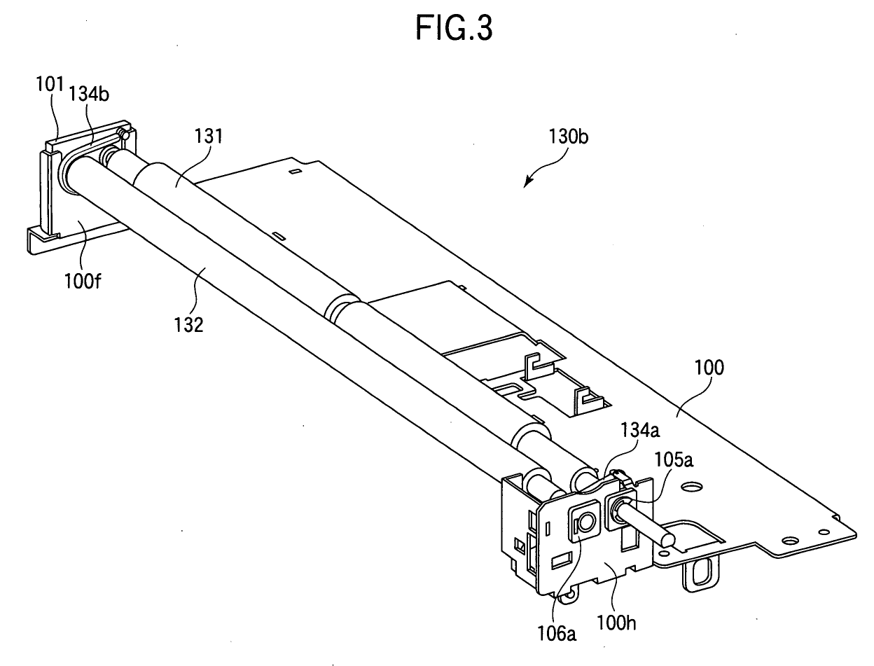

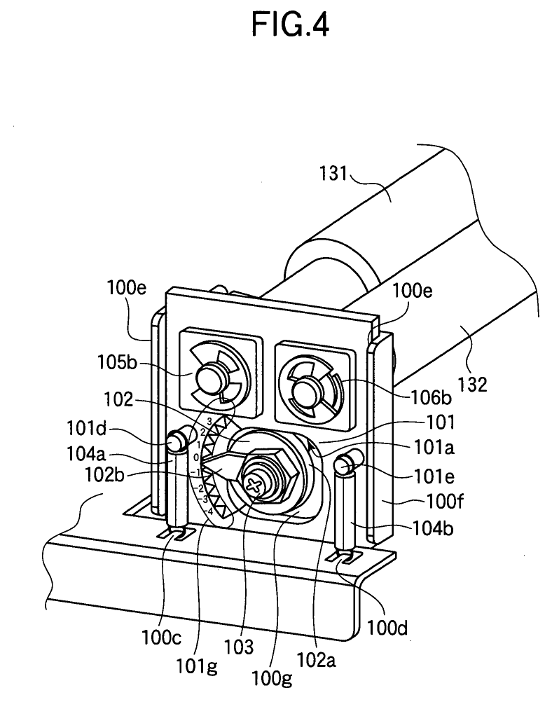

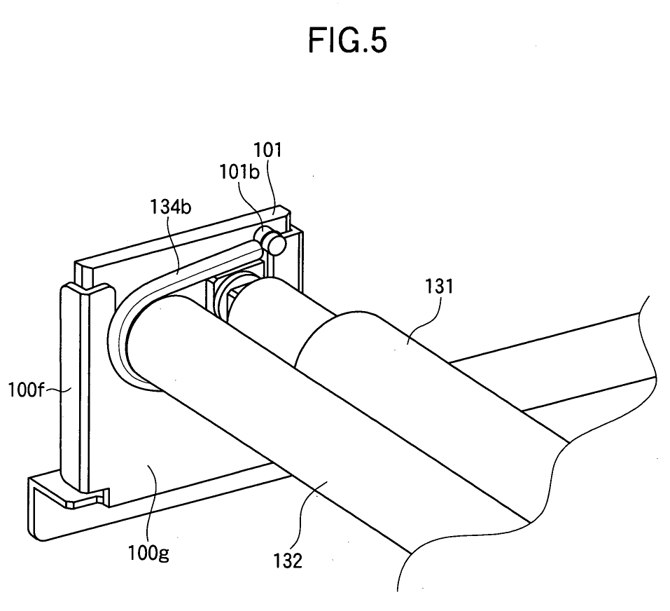

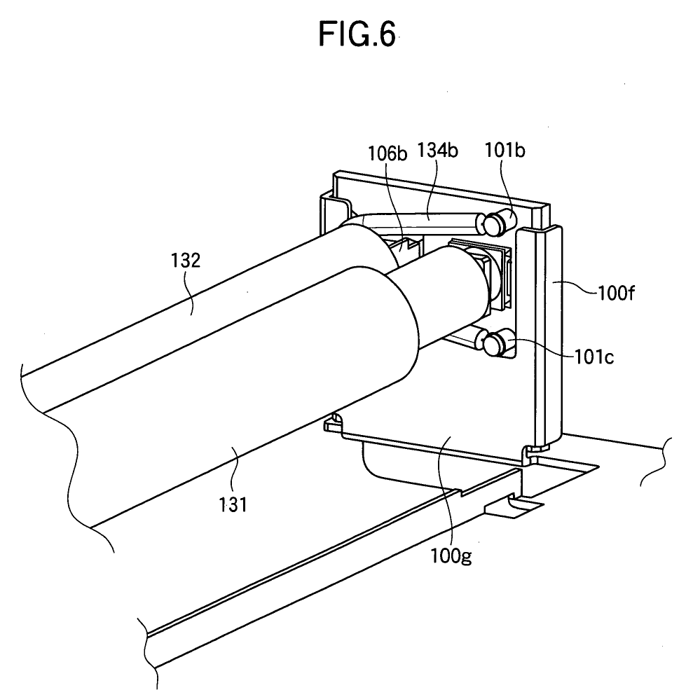

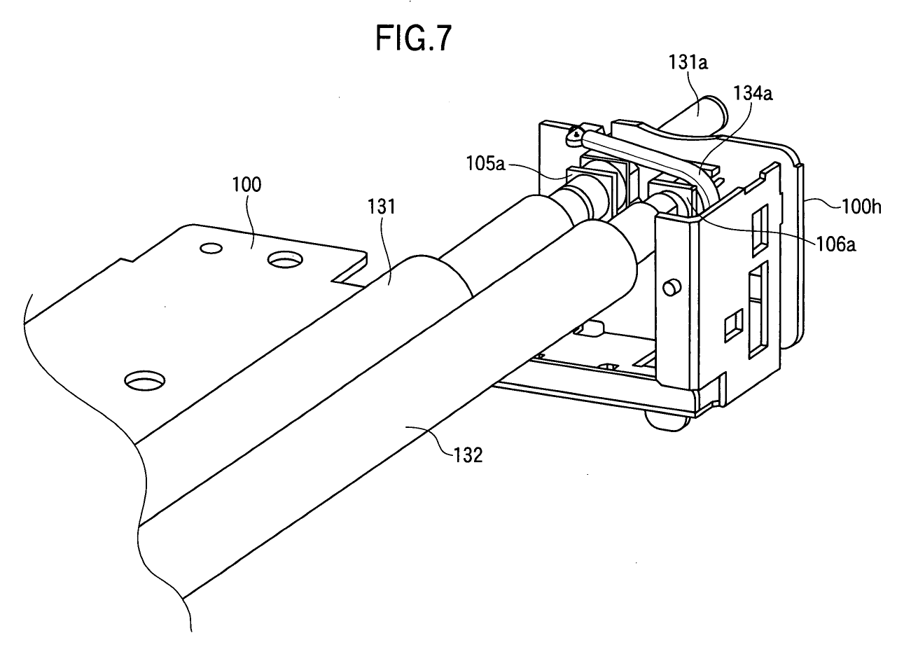

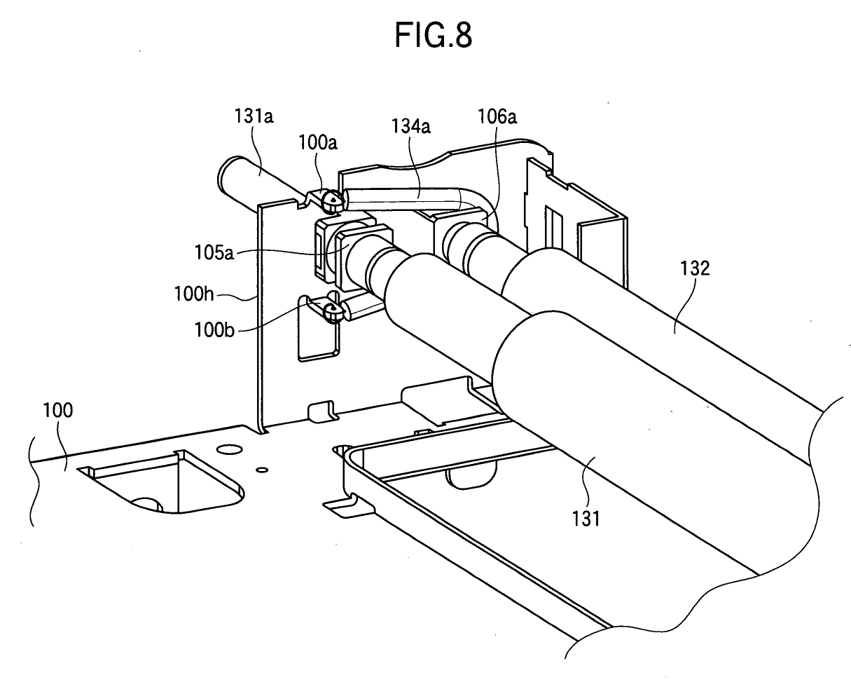

The skew removing mechanism 130b of the additional medium feeding unit 150 will be described. FIG. 2 is a perspective view of the skew removing mechanism 130b of the additional medium feeding unit 150 shown in FIG. 1. FIG. 3 is another perspective view of the skew removing mechanism 130b as seen in a direction shown by arrow C of FIG. 2. FIGS. 4 and 7 are expanded views of pertinent potions of the skew removing mechanism 130b. FIG. 5 is an expanded view of a pertinent portion of FIG. 3. FIG. 6 is a perspective view of a portion shown in FIG. 4 looking in another direction. FIG. 8 is a perspective view of a portion shown in FIG. 7 looking in another direction.

Referring to FIGS. 2 and 3, the skew removing mechanism 130a includes primarily a registry roller 131, a pressure roller 132, bearing collars 105a and 105b and 106a and 106b, a movable holder 101, and a base plate 100. The registry roller 131 cooperates with the pressure roller 132 to remove the skew of the print medium transported in a direction shown by arrow A. The bearing collars 105a and 105b support the shaft of the registry roller 131. The bearing collars 106a and 106b support the shaft of the pressure roller 132. The skew removing mechanism 130b also includes a support 100f that supports the movable holder 101. The support 100f is formed by partially bending a base plate 100 upward. One longitudinal end portion 131a of the registry roller 131 is held on the support 100h, being restricted by the bearing collar 105a from moving laterally. The support 100h houses a gear train (not shown) that drives the registry roller 131 and pressure roller 132 in rotation. Another longitudinal end portion 131b of the registry roller 131 is held on a movable holder 101, being restricted by another bearing collar 105b from moving laterally. Likewise, one longitudinal end portion 132a of the pressure roller 132 is supported on the support 100h, being restricted by the bearing collar 106a from moving laterally as well as being allowed to move toward and away from the registry roller 131. Another longitudinal end portion 132b of the registry roller 132 is held on the movable holder 101, being restricted by another bearing collar 106b from moving laterally but being allowed to move toward and away from the registry roller 31. The registry roller 131 and pressure roller 132 may be called a roller pair hereafter in the specification.

Coil springs 134a and 134b urge the registry roller 131 against the pressure roller 132. Referring to FIGS. 7 and 8, the spring 134a has two ends that are fastened to two hooks 100a and 100b (FIG. 8), respectively, wrapping around the bearing collar 106a that support the pressure roller 132. The spring 134b has two ends that are fastened to two hooks 101b and 101c (FIG. 6), respectively, wrapping around the bearing collar 106b that support the pressure roller 132. The two springs 134a and 134b cooperate with each other to urge the pressure roller 132 against the registry roller 131, so that the pressure roller 132 is in pressure contact with the registry roller 131 under reasonable pressure.

Referring to FIG. 4, a cam 102 is rotatably supported on a back surface 100g of a support 100f formed by partially bending the base plate 100 upward, and includes a cam surface 102a in contact with a cam-receiving surface 101a of the movable holder 101. Two springs 104a and 104b are disposed across the movable holder 101 and a base plate 100. The spring 104a is disposed across a post 101d formed on the movable holder 101 and a post 100c formed on the base plate 100. The spring 104b is disposed across a post 101e formed on the movable holder 101 and a post 100d formed on the base plate 100. Thus, the movable holder 101 is biased by the springs 104a and 104b toward the base plate 100 at all times.

The movable holder 101 is supported by a generally U-shaped support 100f such that the movable holder 101 is movable along rails 100e formed in the support 100f. The opposing walls of the U-shaped support 100f incline somewhat inwardly toward each other so that the movable holder 101 loosely held by the opposing walls but is difficult to drop off. Thus, the cam surface 102a of the cam 102 is in pressure contact with the cam-receiving surface 101a of the movable holder 101. The cam 102 may be set at any rotational position relative to the movable holder 101 by means of a screw 103. The movable holder 101 includes graduation markings 111g marked in nine (9) steps, from −4 to +4. The cam 102 includes a pointer 102b that rotates together with the cam 102 to point to the graduation markings 101g. The movable holder 101, cam 102, springs 104a and 104b, graduation markings 101g, pointer 102b, and screw 103 form an inclination adjusting mechanism. The movable holder 101 and bearing collars 105b and 106b cooperate with the support 100f and bearing collars 105 and 106 to rotatably support the registry roller 131 and pressure roller 132, while the movable holder 101 being movable vertically relative to the support 100f. The shapes of the fitting portions of the respective components are selected taking into consideration the amount of movement of the movable holder 101 and the shapes of the bearing collars, movable holder 101, and support 100f.

The operation of the image forming apparatus 180 of the aforementioned configuration will be described in more detail.

Referring to FIG. 1, the feed roller 170 and separator pad 160a cooperate with each other to advance the print medium from the paper cassette 120 on a page-by-page basis. The print medium abuts the skew removing mechanism 103a, which in turn removes the skew of the print medium. Then, the print medium is transported through the image forming sections 111-114 in sequence, so that toner images of the respective colors are transferred onto the print medium one over the other in registration. Then, the print medium is fed into the fixing device 140 where the toner images are fused into a full color image by heat and pressure. Subsequently, the print medium is discharged from the image forming apparatus 180. This completes printing.

The additional medium feeding unit 150 also includes the paper cassette 150a that holds a stack of print medium. The feed roller 170b and the separator pad 160b cooperate with each other to advance only the top sheet of the stack of print medium. The print medium then abuts the skew removing mechanism 130b, which in turn removes the skew of the print medium. Then, the print medium is transported to the body of the image forming apparatus 180 where the printing process is carried out as described above. When the print medium is fed from the additional medium feeding unit 150, the skew removing mechanism 130a is not operative, and therefore the print medium merely passes through the skew removing mechanism 130a.

If the print medium advances accurately in a direction perpendicular to the rotational axes of photoconductive drums 222a-114a with the leading edge of the print medium parallel to the rotational axes of photoconductive drums, the leading edge of the print medium would be accurately parallel to the rotational axes of the photoconductive drums 111a-114a and the print medium is not skewed. In this application, skew refers to inclination of the print medium with respect to a direction perpendicular to the rotational axes of the photoconductive drums 111a-114a. Skew may also refer to deviation of the direction of travel of the print medium from a direction in which the medium should be transported, or a degree of rotational axes of the first and second rollers being right angle at a direction in which the medium should be transported by the medium transporting mechanism.

Therefore, the rotational axes of the registry roller 131 and pressure roller 132 should extend substantially parallel to the rotational axes of the photoconductive drums 111a-114a, so that the skew removing mechanism 130b properly removes the skew of the print medium. Of course, the rotational axes of the registry roller 131 and pressure roller 132 should be substantially parallel to each other.

Referring to FIG. 2, the print medium is transported in the A direction until the entire leading edge abuts the nip formed between the registry roller 131 and pressure roller 132 of the skew removing mechanism 130b, and then the skew removing mechanism 130b starts to rotate at a proper timing. In other words, the transportation of the print medium starts only after the leading edge of the print medium has become sufficiently parallel to the rotational axes of the skew removing mechanism 130a. For example, when the print medium advances in the A direction, if the print medium is skewed such that the left end of the leading edge of the print medium is ahead of the right end of the leading edge, the image printed on the print medium is closer to the leading edge at the right end portion of the image than at the left end portion of the image. In other words, the distance between the leading edge of the print medium and the left end of the leading edge of the printed image is longer that the distance between the leading edge of the print medium and the right end of the leading edge of the printed image.

Conversely, when the print medium advances in the A direction, if the print medium is skewed such that the right end of the leading edge of the print medium is ahead of the left end of the leading edge, the image printed on the print medium is closer to the leading edge at the left end portion of the image than at the right end portion of the image. In other words, the distance between the leading edge of the print medium and the right end of the leading edge of the printed image is longer that the distance between the leading edge of the print medium and the left end of the leading edge of the printed image.

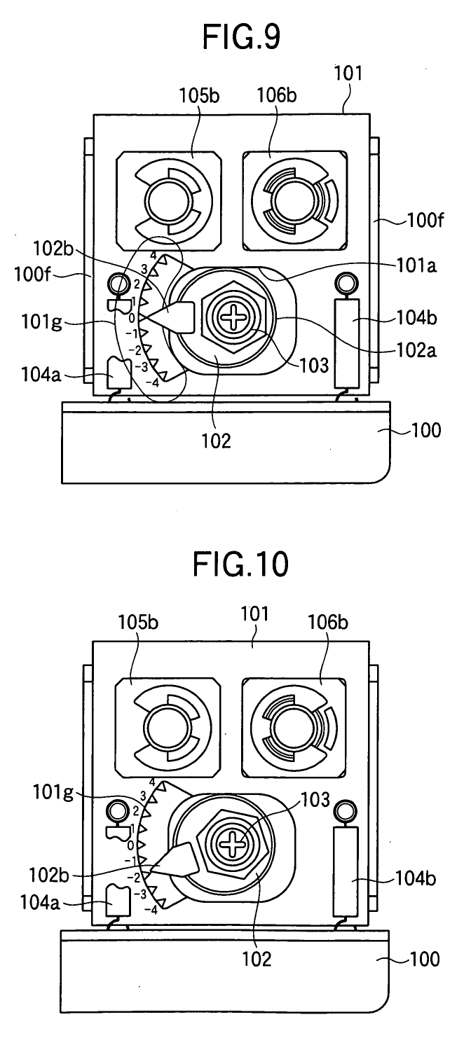

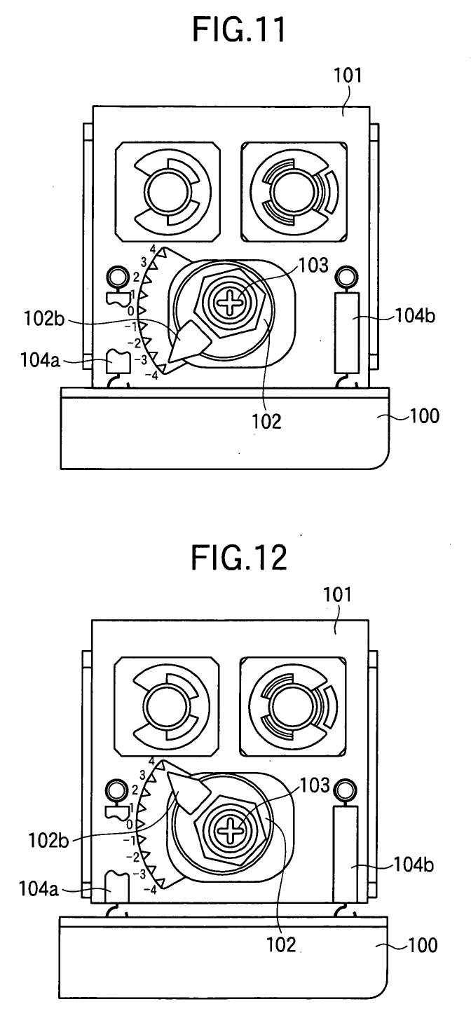

The operation of the inclination adjusting mechanism will be described with reference to FIGS. 9-12.

FIGS. 9-12 illustrate the rotational positions of the cam 102.

The cam 102 is usually adjusted before shipment such that the pointer 102b pints to “0” of the graduation markings 101g on the holder 101 as shown in FIG. 9. The marking “0” is a position such that the height of the movable holder 101 relative to the base plate 100 is substantially at a mid point in a range in which the height may be adjusted. When the pointer 102b points to “−4” of the graduation markings 101g, the height of the movable holder 101 relative to the base plate 100 is lowest. When the pointer 102b points to “+4” of the graduation marking 101g, the height of the movable holder 101 relative to the base plate 100 is highest.

If the right end of the skew removing mechanism 130b is slightly upstream of where it should be (i.e., deviates in a negative Z direction), the image printed on the print medium is closer to the leading edge of the print medium at the right end portion of the image than at the left end portion of the image. Therefore, the screw 103 of the cam 102 is loosened and then the cam 102 is rotated counterclockwise to cause the movable holder 101 to move toward the base plate 100. In other words, the left end of the skew removing mechanism 130b is moved upstream until the pointer 102b points to, for example, “−2” so that the rotational axes of the registry roller 131 and pressure roller 132 of the skew removing mechanism 130b are again parallel to the rotational axes of the respective photoconductive drums 111a-114a. Then, the screw 103 is tightened. The left end of the skew removing mechanism 130b may be moved up to a position where the pointer 102b points to “−4”.

As described above, if the right end of the skew removing mechanism 130b is slightly upstream of where it should be, the left end is moved slightly upstream, thereby preventing a skew problem in which the left end of the leading edge of the print medium is ahead of the right end of the leading edge. In this manner, the skew of the print medium is removed.

Likewise, if the left end of the skew removing mechanism 130b is slightly upstream of where it should be (i.e., the left end deviates in a negative Z direction), the image printed on the print medium is closer to the leading edge of the print medium at the right end portion of the image than at the left end portion of the image. Therefore, the screw 103 of the cam 102 is loosened and then the cam 102 is rotated clockwise to cause the holder 101 to move away from the base plate 100. In other words, the left end of the skew removing mechanism 130b is moved downstream until the pointer 102b points to, for example, “+2” so that the rotational axes of the registry roller 131 and pressure roller 132 of the skew removing mechanism 130b are again parallel to the rotational axes of the respective photoconductive drums 111a-114a. Then, the screw 103 is tightened. The left end of the skew removing mechanism 130b may be moved up to a position where the pointer 102b points to “+4”.

As described above, if the left end of the skew removing mechanism 130b is slightly upstream of where it should be, the left end is moved slightly downstream, thereby preventing a skew problem in which the right end of the leading edge of the print medium is ahead of the left end of the leading edge. In this manner, the skew of the print medium is removed.

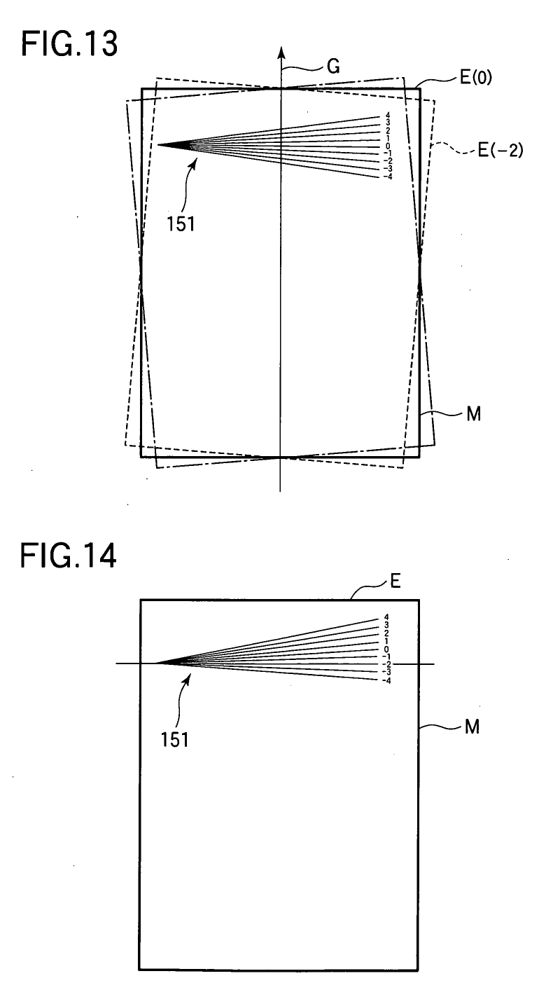

A method for facilitating removal of the skew of print medium will be described. This method employs a skew adjusting print pattern shown in FIGS. 13-15.

FIG. 13 illustrates the orientations of a print medium M and the positions of the leading end of an image printed on the print medium for different positions pointed by the pointer 102b, providing that when the pointer 102b points to “0,” the axes of the registry roller 131 and pressure roller 132 are parallel to the rotational axes of the respective photoconductive drums 111a-114a. The leading end of the image printed on the print medium has nine (9) different positions ranging from “−4” to “+4” depending on the amount and orientation of skew. It is to be noted that when the pointer 102b points to “0,” the leading end of the image printed on the print medium is substantially parallel to the leading edge of the print medium. Referring to FIG. 13, the print medium M is oriented as shown by E(0) if the pointer 102b points to “0,” E(3) if the pointer 102b points to “3,” and E(−2) if the pointer 102b points to “−2.”

If the print medium is not skewed, the print medium travels in a direction G. Dotted lines and dot-dashed lines show the orientations of the print medium that depend on the direction of skew of the print medium.

FIG. 14 illustrates the skew adjusting print pattern 151 when the print medium is skewed as shown in dotted line orientation E(−2) in FIG. 13. In other words, the left end of the leading edge of the print medium is ahead of the right end of the leading edge. Therefore, the image printed on the print medium is closer to the leading edge at the right end portion of the image than at the left end portion of the image.

Each one of the nine lines from “−4” to “+4” shown in FIG. 14 represents a corresponding one of the nine positions of the graduation markings 101g (FIG. 9). That is, when the position of the cam 102 is adjusted by operating the pointer 102b so that the pointer 102b points to one of the nine positions of the graduation marking 101g, the positions of the left and right ends of the leading end of an image printed on the print medium would be those as shown in FIG. 14.

Referring to FIG. 14, if a line of “−2” is parallel to the leading edge E of the print medium M, then the position of the cam 102 is adjusted by turning the pointer 102b counterclockwise until the pointer 102b points to “−2,” thereby moving the left ends of the rotational axes of the registry roller 131 and pressure roller 132 to a position upstream of where they were. This removes the skew of the print medium, so that a line of “0” becomes parallel to the leading edge of the print medium M.

Likewise, if a line of “−4” is parallel to the leading edge E of the print medium, then the position of the cam 102 is adjusted by turning the pointer 102b counterclockwise until the pointer points to “−4,” thereby moving the left ends of the rotational axes of the registry roller 131 and pressure roller 132 to a position upstream of where they were. This removes the skew of the print medium so that a line of “0” on the skew adjusting print pattern 151 becomes parallel to the leading edge of the print medium.

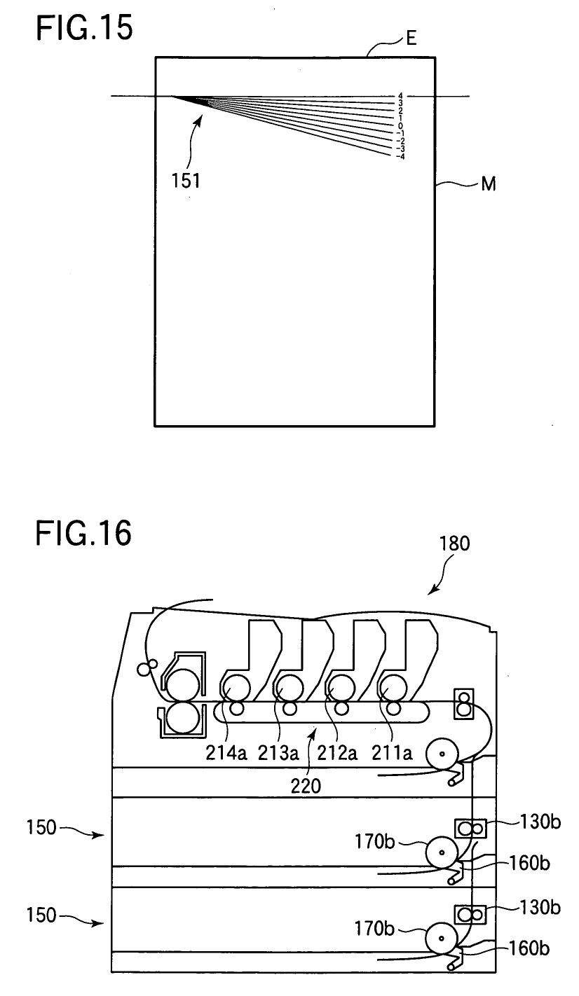

FIG. 15 illustrates the skew adjusting print pattern 151 when the print medium is skewed as shown in dot-dashed lines in FIG. 13. In other words, the right end of the leading edge of the print medium is ahead of the left end of the leading edge. Therefore, the image printed on the print medium is closer to the leading edge at the left end portion of the image than at the right end portion of the image.

Referring to FIG. 15, if a line of “4” is parallel to the leading edge E of the print medium, then the position of the cam 102 is adjusted by turning the pointer 102b clockwise until the pointer 102b points to “4,” thereby moving the left ends of the rotational axes of the registry roller 131 and pressure roller 132 to a position downstream of where they were. This removes the skew of the print medium so that a line of “0” on the skew adjusting print pattern 151 becomes parallel to the leading edge of the print medium. The markings on the movable holder 101 and the numerals on the skew adjusting print pattern 151 may be another type of index indicative of the amount of movement of the movable holder 101 or the amount of skew. The markings may be a distance (e.g., X mm) over which the movable holder 101 should move or the amount of skew.

Here, it is assumed that the image forming apparatus 180 receives the skew adjusting print pattern 151 from an external apparatus such as a personal computer. Alternatively, the skew adjusting print pattern 151 may be stored in a non-volatile memory device resident within the image forming apparatus 180, in which case the skew adjusting print pattern may be read from the memory and printed when skew adjustment is performed.

The first embodiment has been described with respect to a case in which the image forming apparatus 180 includes a single additional medium feeding unit 150. A larger number of additional medium feeding units may be installed under the additional medium feeding unit 150. FIG. 16 illustrates an image forming apparatus that employs two additional medium feeding units 150 and 150.

As described above, the rotational axes of the registry roller 131 and pressure roller 132 may be adjusted to a desired level of parallelism between the skew removing mechanism and the respective photoconductive drums 211a-214a. This leads to a skew-free image forming apparatus. The bearings that support the longitudinal end portions of the registry roller 131 and pressure roller 132 may be worn out over time, causing a non-uniform distribution of pressing force acting on the registry roller 131 and pressure roller 132 in their longitudinal directions. This gives rise to skew of the print medium. The first embodiment is effective in adjusting the inclination of the skew removing mechanism to correct the skew of the print medium, thereby providing an image forming apparatus having high image quality.

Whenever an additional medium feeding unit is installed, a skew problem of print medium is apt to occur. The first embodiment allows adjustment of the inclination of the rotational axes of the registry roller 131 and pressure roller 132 relative to those of the respective photoconductive drums 111a-114a, thereby achieving a desired level of parallelism between the skew removing mechanism and the respective photoconductive drums 211a-214a. It is to be noted that the position of the skew adjusting print pattern 151 relative to the leading edge of the print medium ultimately reflects all of factors that cause skew. Such factors include the degrees of parallelism between the axes of the registry roller 131 and pressure roller 132 and the axes of the photoconductive drums and transfer rollers, the variations in the nips formed between the registry roller 131 and pressure roller 132, and the variations in the nips between the photoconductive drums and transfer rollers. Correcting the skew of the print medium by the using the skew adjusting print pattern 151 is advantageous in correcting skew caused by all of the aforementioned factors.

When an image forming apparatus equipped with a conventional medium feeding apparatus is placed on a table or a floor not sufficiently horizontal due to distortion or warp, rollers along the transport path of the print medium in the apparatus do not lie in sufficiently horizontal planes. This may lead to skew of print medium in the apparatus. Mounting an additional medium tray(s) to the image forming apparatus increases a total number of components of the image forming apparatus. Therefore, it will be difficult to maintain medium-transporting rollers in substantially horizontal planes and parallel to one another if medium-transporting rollers of additional medium trays are somewhat inclined relative to the horizontal planes, the problem would be more serious. The result would be more serious. The first embodiment may be effectively applied for overcoming the skew problem of the paper.

### Second Embodiment

In the first embodiment, the adjustment of the degree of parallelism of the skew removing mechanism with respect to the axes of the photoconductive drums involves partial exposure of internal mechanisms. Therefore, a serviceman would have some difficulty in adjusting the parallelism of the axes of the registry roller 131 and pressure roller 132 of the skew removing mechanism. A second embodiment is intended to solve this drawback.

### {Skew Removing Mechanism}

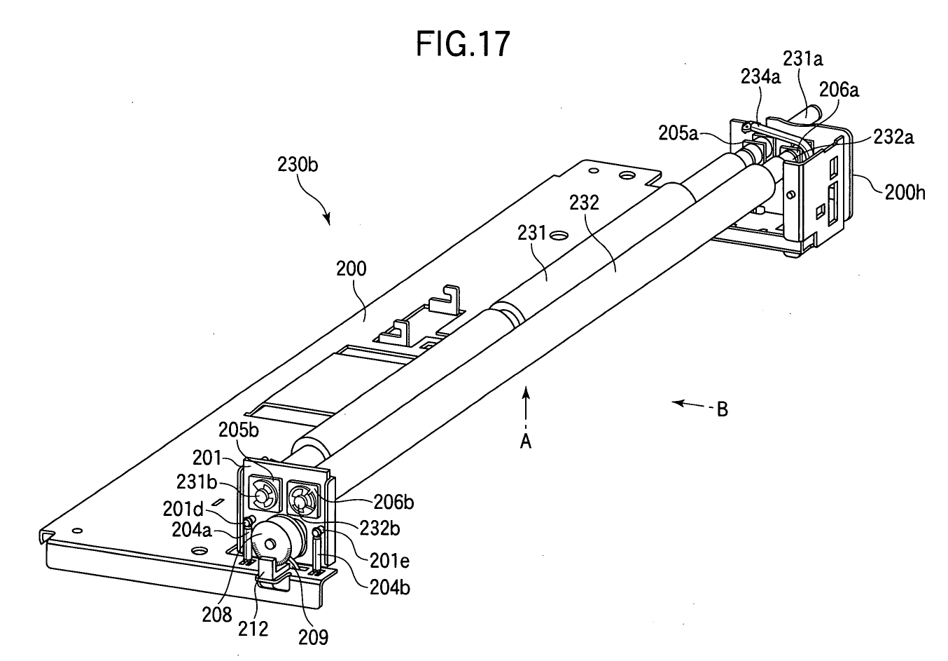

FIG. 17 is a perspective view illustrating a skew removing mechanism 230b of the second embodiment.

The skew removing mechanism 230b of the second embodiment differs from the skew removing mechanism 130a of the first embodiment in that a cam driving mechanism is employed and a controller for driving the cam driving mechanism is added. Elements similar to those of the first embodiment have been given the same reference numerals and their description is omitted. Thus, a description is given only of portions different from the first embodiment. The configuration of the image forming apparatus of the second embodiment is the same as that of the first embodiment (FIG. 1) except for the skew removing mechanism 230b. Thus, the second embodiment will be described with reference to FIG. 1 as required.

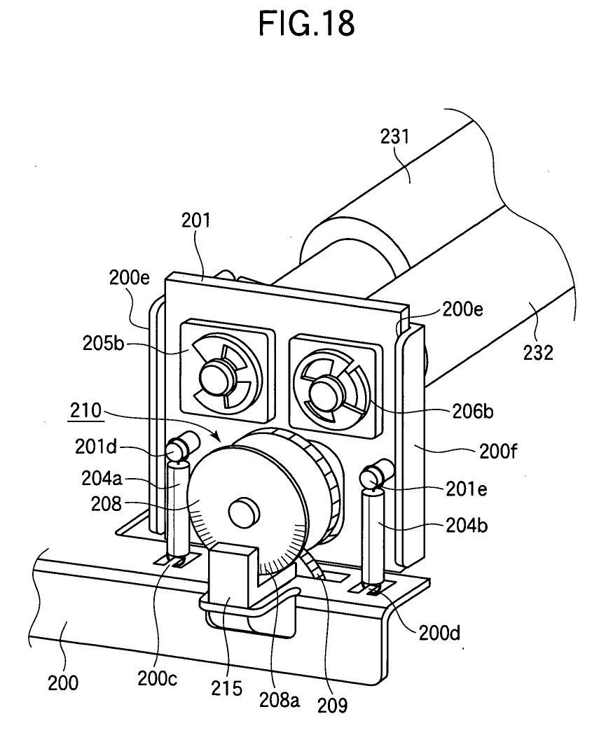

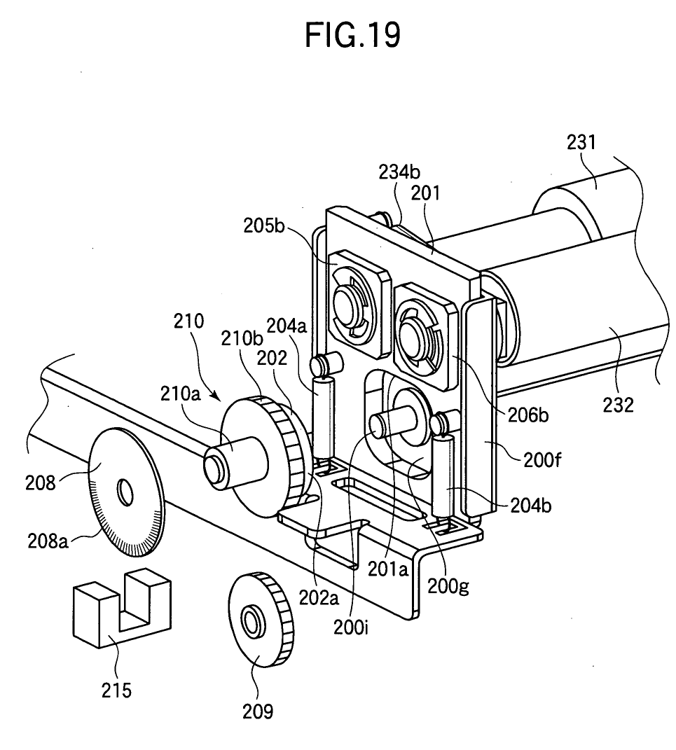

FIG. 17 is a perspective view of the skew removing mechanism 230b as seen in the same direction as FIG. 2. FIG. 18 is an expanded view illustrating a pertinent portion of FIG. 17. FIG. 19 is an exploded perspective view illustrating a pertinent portion of the cam driving mechanism.

Referring to FIG. 17, the skew removing mechanism 230b includes a registry roller 231, a pressure roller 232, bearing collars 205a and 205b, bearing collars 206a and 206b, a movable holder 201, and a base plate 200. One longitudinal end portion 231a of the registry roller 231 is held on the base plate 200, being restricted by the bearing collar 205a from moving laterally. Another longitudinal end portion 231b of the registry roller 231 is held on a movable holder 201, being restricted by the bearing collar 205b from moving laterally. Likewise, one longitudinal end portion 232a of the pressure roller 232 is supported on the support 200h, being restricted by the bearing collar 206a from moving laterally as well as being allowed to move toward and away from the registry roller 231. Another longitudinal end portion 232b of the registry roller 232 is held on a movable holder 201, being restricted by the bearing collar 206b from moving laterally as well as being allowed to move toward and away from the registry roller 131.

Coil springs 234a (FIG. 17) and 234b (FIG. 19) urge the registry roller 231 against the pressure roller 232. Just as the springs 131a and 131b, the spring 234a has two ends that are fastened to hooks 200a and 200b (FIG. 8), respectively, wrapping around the bearing collar 206a that support the pressure roller 232. The spring 234b has two ends that are fastened to hooks (corresponding to hooks 101b and 101c shown in FIG. 6), respectively, wrapping around the bearing collar 206b that support the pressure roller 232. The two springs 234a and 234b cooperate with each other to urge the pressure roller 232 against the registry roller 231, so that the pressure roller 232 is in pressure contact with the registry roller 231 under reasonable pressure.

Referring to FIGS. 18 and 19, a cam 202 is disposed such that a cam surface 202a of the cam 202 abuts a cam-receiving surface 201a of the movable holder 201. Springs 204a and 204b are disposed across the movable holder 201 and a base plate 200. The spring 204a is disposed across a post 201d formed on the movable holder 201 and a post 200c formed on the base plate 200. The spring 204b is disposed across a post 201e formed on the movable holder 201 and a post 200d formed on the base plate 200. Thus, the movable holder 201 is biased toward the base plate 200 at all times. The cam 202 of the second embodiment is of the same configuration as the cam 202 of the first embodiment.

The support 200f is formed by partially bending the base plate 200 upward, and is generally U-shaped. The movable holder 201 is supported such that the movable holder 201 is movable along rails 200e which are part of the support 200f. A stationary shaft 200i projects from a back surface 200g of the support 200f, and a cam-and-gear 210 is rotatably supported on the support 200f. The shapes of the fitting portions of the respective components are selected taking into consideration the amount of movement of the movable holder 101 and the shapes of the bearing collars 205a-205b and 206a-206b, movable holder 201, and supports 200h and 200f.

The cam-and-gear ( [symbol] ) 210 includes the cam 202, a gear 210b, and a rotational shaft 210a formed in one piece construction, and is rotatable about the rotational shaft 210a. The rotational shaft 210a is formed with a hole (not shown) therein into which the stationary shaft 200i extends fittingly. Once the cam-and-gear 210 is mounted to the support 200f by inserting the stationary shaft 200i into the hole, the cam-and-gear 210 is rotatable about the stationary shaft 200i. The cam surface 202a is eccentric to the stationary shaft 200i so that when the cam 202 rotates, the cam surface 202a causes the movable holder 201 to vertically slide along the rails 200e.

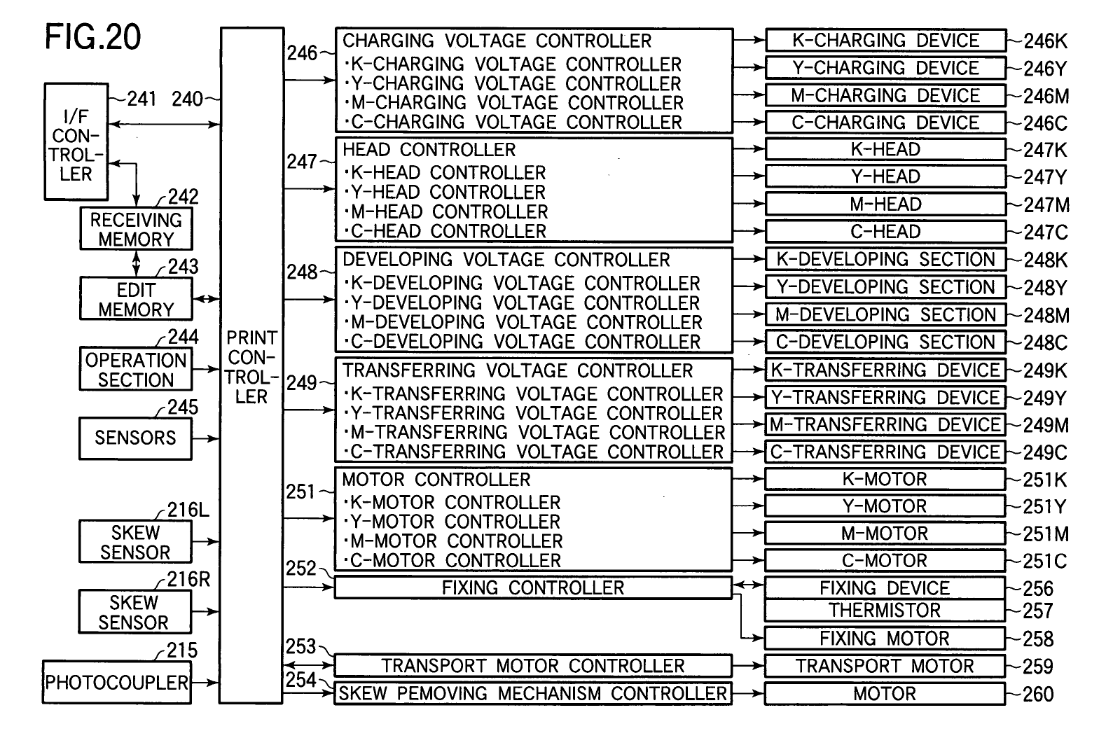

The gear 210b is in mesh with an idle gear 209 to which a rotational force is transmitted from a drive source (not shown) A disc 208 in which slits 208a are cut is attached to the free end portion of the rotational shaft 210a. A photocoupler 215 is generally U-shaped, and includes a light emitting element and a light receiving element. The photocoupler 215 is mounted to a base plate 200 (FIG. 17) such that the slits 208a of the disc 208 is between the light emitting element and light receiving element. The light emitted from the light emitting element enters the light receiving element through the slits 208a. Thus, the photocoupler 204 detects the rotational conditions of the disc 208, and transmits a detection signal representative of rotation of the cam 202 to the controller 240 (FIG. 20).

The skew sensors 216L and 216R are disposed downstream of the skew removing mechanism 230, the skew sensor 216L being on the left side of a transport path of the print medium and the skew sensor 216R being on the right side of the transport path. The skew sensors 216L and 216R detect the leading edge of the print medium. The distance between the skew sensor 216L and the skew sensor 216R is shorter than the minimum width of the print medium transported in the transport path.

The skew sensors 216L and 216R require to be disposed upstream of the image forming sections 211-214 (corresponding to those 111-114 shown in FIG. 1). This is because the skew of the print medium must have been removed before the print medium enters the image forming sections.

### {Controller}

FIG. 20 is a block diagram illustrating a pertinent portion of a controller that controls the operation of an image forming apparatus of the second embodiment.

The print controller 240 includes a CPU, a ROM, a RAM, an I/O ports, and a timer (not shown). The print controller 240 receives print data and control commands from a host apparatus, and controls the sequence of the overall operation of the image forming apparatus when printing is performed. An I/F controller 241 transmits printer information to the host apparatus. The I/F controller 241 also parses the commands received from the host apparatus, and processes data received from the host apparatus. A receiving memory 242 temporarily stores the data received from the host apparatus, the data being separated into data for individual colors under the control of the I/F controller 241. An operation section 244 includes LED indicators that indicate various statuses of the image forming apparatus, and switches via which a user inputs the commands into the image forming apparatus. Sensors 245 include a plurality of sensors that detect the positions of the print medium in the image forming apparatus, sensors that detect temperature and humidity within the image forming apparatus, and sensors that detect print density of printed images. The detection outputs of these sensors 245 are input into the print controller 240.

An edit memory 243 is used when image data is edited based on the print data received from the host apparatus through the I/F controller 241. The edit memory 243 receives the print data temporarily stored in the receiving memory 242, and the I/F controller 241 edits the image data based on the print data and stores the image data into the edit memory 243.

Under the control of the print controller 240, a charging voltage controller 246 controls the charging device to charge the surfaces of the photoconductive drums (corresponding to those 111a-114a shown in FIG. 1). Because the control of the charging voltage is performed for the respective colors independently, the charging voltage controller 246 includes a K-charging voltage controller (black) for a K-charging device 246K, a Y-charging voltage controller (yellow) for a Y-charging device 246Y, an M-charging voltage controller (magenta) for an M-charging device 246M, and a C-charging voltage controller (cyan) for a C-charging device 246C.

A head controller 247 performs control for illuminating the charged surfaces of the photoconductive drums in accordance with the image data read from the edit memory 243 to form electrostatic latent images of corresponding colors. Because the control for forming electrostatic latent images is performed separately for individual colors, the head controller 247 includes a K-head controller, a Y-head controller, an M-head controller and a C-head controller. The K-, Y-, M-, and C-head controllers transmit corresponding image data to a K-head 247K, a Y-head 247Y, an M-head 247M, and a C-head 247C, respectively, at appropriate timing.

A developing voltage controller 248 controls developing voltages for developing the electrostatic latent images formed on the photoconductive drums with toners of corresponding colors. Because development is performed separately for electrostatic latent images of individual colors, the developing voltage controller 248 includes a K-developing voltage controller, a Y-developing voltage controller, an M-developing voltage controller, and a C-developing voltage controller. The K-, Y-, M-, and C-developing voltage controllers control a K-developing section 248K, a Y-developing section 248Y, an M-developing section 248M, and a C-developing section 248C, respectively, to develop electrostatic latent images into toner images of corresponding colors.

Under the control of the print controller 240, a transferring voltage controller 249 performs control of the voltages applied to the transferring devices 249K-249C, thereby transferring the toner images from the photoconductive drums onto the print medium one over the other in registration. Because transfer of images is performed separately at different timing for electrostatic latent images of individual colors, the transferring voltage controller 249 includes a K-transferring controller, a Y-transferring controller, an M-transferring controller, and a C-transferring controller. These K-, Y-, M-, and C-transferring controllers control voltages supplied to a K-transferring device 249K, a Y-transferring device 249Y, an M-transferring device 249M, and a C-transferring device 249C.

A motor controller 251 includes a K-motor controller, a Y-motor controller, an M-motor controller, and a C-motor controller. The K-motor controller controls a K-motor 251K that drives the photoconductive drums, charging devices and developing devices. The Y-motor controller controls a Y-motor 251Y. The M-motor controller controls an M-motor 251M. The C-motor controller controls a C-motor 251C. A fixing controller 252 controls the voltage applied to a heater built in the fixing device 256 (corresponding to that shown in FIG. 1) in response to a command from the print controller 240, thereby fixing the toner images on the print medium. The fixing controller 252 receives a temperature detection signal from a thermistor 257 that detects the temperature of the fixing device 256, and controls the on-and-off operation of the heater in accordance with the temperature detection signal. When the temperature detection signal reaches a predetermined value, the fixing controller 252 starts the controlling of a fixing motor 258, which in turn drives the fixing rollers in rotation.

The photocoupler 215 is mounted to the base plate 200 with the disc 208 disposed such that the slits 208a are between the light emitting element and the light receiving element. Light emitted from the light emitting element enters the light receiving element through the slits 208a formed in the disc 208, thereby detecting the angular position of the disc 208 as well as transmitting information on the angular position of the cam 202. In response to a command from the print controller 240, a skew removing mechanism controller 254 controls a motor 260 to drive the cam-and-gear 210 (FIG. 18) in rotation to adjust the inclination of the skew removing mechanism 230. The rotation of the motor 260 is transmitted to the cam-and-gear 210 through a rotation transmitting system (not shown) and an idle gear 209. The skew removing mechanism controller 254 drives the motor 260 with pulses, thereby causing the cam-and-gear 210 to rotate through an angle proportional to the number of pulses.

Under the control of the print controller 240, a transport motor controller 253 drives a transport motor 259 in rotation, so that the transport motor 259 drives the registry roller 231 in rotation through a gear train (not shown) to transport the print medium in the A direction (FIG. 17).

The operation of the skew removing mechanism 230b of the aforementioned configuration will be described.

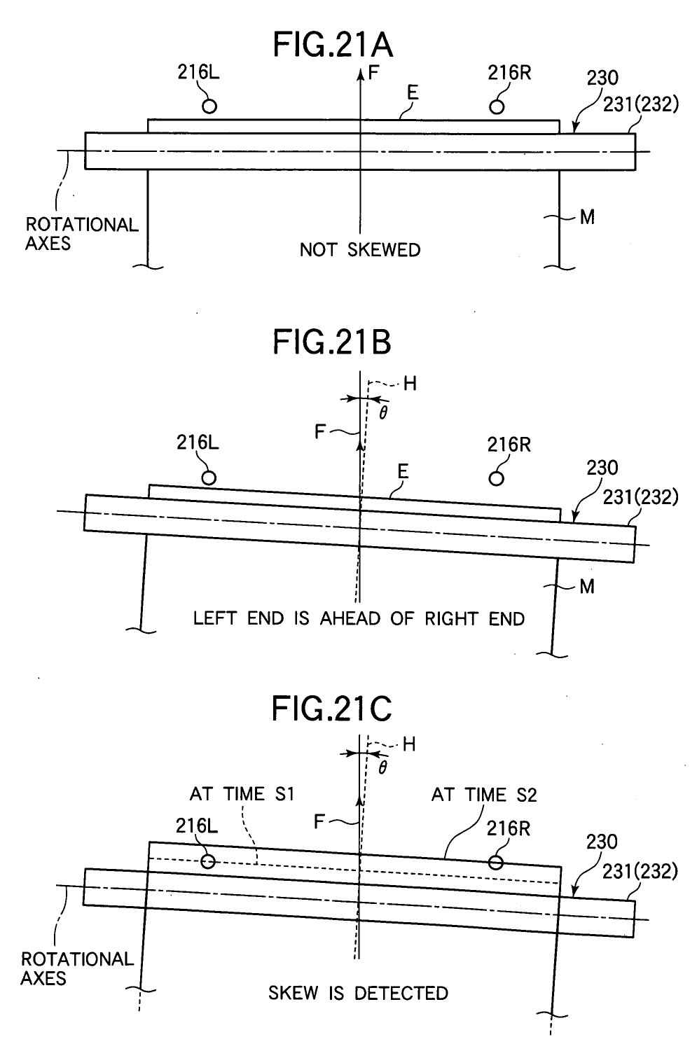

FIGS. 21A-21C illustrate how the skew sensors 216L and 216R detect the skew of the print medium E advanced by the skew removing mechanism 230b. FIGS. 21A-21C show the skew removing mechanism 230b as seen in the B direction shown in FIG. 17.

Assuming that the registry roller 231 and pressure roller 232 are substantially parallel to the axes of the photoconductive drums 211a, 212a, 213a, and 214a, the print medium M is transported by the skew removing mechanism 230b in a direction shown by arrow F.

Referring to FIGS. 21A-21C, the skew of the print medium M is removed by the skew removing mechanism 230b before the print medium M is advanced further. The skew removing mechanism 230b allows the print medium to advance after the leading edge E of the print medium M has been aligned parallel to the rotational axes of the registry roller 231 and pressure roller 232. If the rotational axes of the registry roller 231 and pressure roller 232 are not substantially parallel to those of the photoconductive drums 211a, 212a, 213a, and 214a, the skew of the print medium is not removed. Therefore, correction or removal of the skew of the print medium refers to the operation in which the print medium is advanced with the leading edge of the print medium aligned substantially parallel to the rotational axes of the registry roller 231 and pressure roller 232.

The skew sensors 216L and 216R detect the leading edge E of the print medium M when the print medium M is transported by the skew removing mechanism 230b past these skew sensors 216L and 216R. The outputs of the skew sensors 216L and 216R are transmitted to the print controller 240. The print controller 240 determines the amount of skew of the print medium M from the difference in timing at which these skew sensors 216L and 216R detect the print medium M. A description will be given of the method for detecting the amount of skew of the print medium.

There may exist some positional errors of the skew sensors 216L and 216R, causing a small difference in time between the detection outputs of the skew sensors 216L and 216R when the print medium having no skew passes the skew sensors 216L and 216R. The small difference in time between the detection outputs of the skew sensors 216L and 216R may be vary from apparatus to apparatus. Thus, before the image forming apparatus 180 is shipped from the factory, an amount of skew is measured, and the motor 260 is controlled to adjust the position of the axes of the registry roller 131 and pressure roller 132 to correct the skew. Then, a print medium is transported past the skew sensors 216L and 216R to measure the difference S0 in time between the detection outputs of the skew sensors 216L and 216R. The difference S0 is then stored in a corresponding image forming apparatus. The difference S0 is calculated as follows:

S0=S2−S1 Eq.(1)

When the image forming apparatus is used, the amount of skew is determined in terms of the difference in timing at which the left and right ends of the leading edge of the print medium pass the skew sensors 216L and 216R, respectively. Referring to FIG. 21A, if there is no significant amount of skew, the skew sensors 216L and 216R detect the leading edge of the medium substantially at the same time. Conversely, if there is an amount of skew occurs such that the left end of the leading edge of the print medium is ahead of the right end of the leading edge, the leading edge is detected earlier by the skew sensor 216L than by the skew sensor 216R. The difference S in time at which the skew sensors 216L and 216R detect the leading edge of the print medium is given as follows:

S=(S2−S0)−S1 Eq. (2)

where S is the difference in time, S1 is the time at which the skew sensors 216L detects the leading edge of the print medium, and S2 is the time at which the skew sensors 216R detects the leading edge of the print medium. If the value of S isles than a predetermined value, then it is determined that there is no significant skew and correction of skew is not performed.

### {Home Position of Cam}

The home position of the cam 202 will be described.

The home position of the cam 202 is such that the left end of the registry roller 231 of the skew removing mechanism 230b is at a downstream end of its stroke. Thus, if the motor 260 rotates from the home position in such a direction as to cause the cam 202 to rotate counterclockwise (FIG. 18), the left end of the registry roller 231 of the skew removing mechanism moves from downstream to upstream (opposite to the A direction shown in FIG. 18) with respect to the direction of travel of the print medium. The amount of rotation of the cam 202 is set in accordance with the amount of skew.

A description will be given of how the required amount of rotation of the cam 202 or the number of pulses to be supplied to the motor 260 may be determined based on the amount of skew of the print medium.

The difference S is determined based on the outputs of the skew sensors 216L and 216R by using Equation (2). The difference S is multiplied by a coefficient T (i.e., number of pulses per unit time of S) to obtain the number of pulses Ts required for correcting the inclination of the skew removing mechanism 230. A basic number of pulses To is the number of pulses required for the cam 202 to move from the home position to the current position. The number of pulses Ts is added to the basic number of pulses To to obtain the number of pulses Tm that should be supplied to the motor 260.

Ts=S×T Eq. (3)

Tm=Ts+To Eq. (4)

Because the cam 102 is returned to the home position before adjusting the position of the cam 202, the basic number of pulses To is added to the number of pulses Ts.

The operation of the skew removing mechanism 230b will be described.

### {When Left End of the Leading Edge of Print Medium is Ahead of Right End}

The fact that the left end of the leading edge of the image printed on the print medium is ahead of the right end of the leading edge implies that the left end of the registry roller 231 of the skew removing mechanism 230b is downstream of the right end of the registry roller 231 with respect to the direction of travel of the print medium (F direction). Therefore, the skew removing mechanism 230b is automatically adjusted to move the left ends of the registry roller 231 and pressure roller 232 more upstream. This automatic adjustment is performed as follows:

The number of pulses Ts is first determined from the outputs of the skew sensors 216L and 216R by using equation (3). Then, the cam 202 is returned to the home position. For this purpose, the motor 260 rotates in the forward direction to cause the cam 202 and disc 308 to rotate clockwise in FIG. 18. During the rotation of the disc 208, the photocoupler 204 reads the slits 308a. Because the slits 308a are formed only in a limited circumferential area of the disc 208, the photocoupler 204 eventually fails to output the detection signal as the disc 308 rotates. When the photocoupler 204 fails to output the detection signal, the print controller 240 determines that the cam 202 has reached the home position, and then stops driving the motor 260.

When the cam 202 rotates clockwise together with the disc 208, the cam 202 reaches the home position, i.e., a position where the photocoupler 215 no longer detects any slit after having detected a series of circumferentially arranged slits 208a. The print controller 240 stores the number of pulses supplied to the motor from when the cam 202 and disc 208 start to rotate clockwise until they reach a position corresponding to the home position. This number of pulses is the basic number of pulses, To.

The motor 260 drives the cam 202 and disc 208 to rotate counterclockwise (FIG. 18) through an angle equivalent to the number of pulses Tm obtained by equation (4). Therefore, the cam 202 and disc 208 are first rotated by the number of pulses To, so that the left end of the skew removing mechanism 230b moves upstream to the FIG. 21B position. Then, the cam 202 and disc 208 are further rotated by the number of pulses Ts, so that the left end of the skew removing mechanism 230b moves further upstream to the FIG. 21A position where the skew has been completely removed.

### {When Right End of the Leading Edge of Print Medium is Ahead of Left End}

Conversely, the fact that the right end of the leading edge of the print medium M is ahead of the left end of the leading edge implies that the left ends of the registry roller 231 and pressure roller 232 have deviated to a position upstream of where they should be. Thus, the inclination of the axes of the registry roller 231 and pressure roller 232 is corrected in the previously described manner. In this case, the value of Ts in equation (4) is a negative value, and therefore the left end of the skew removing mechanism 230b will come to rest at the FIG. 21A position at which the skew has been removed.

As described above, the sensors 216L and 216R detect the amount of skew of the print medium and the inclination of the skew removing mechanism may be automatically corrected in accordance with the detected amount of skew. Thus, the second embodiment provides not only the same advantages as the first embodiment but also stable print quality at all times. Because the mechanical assembly in the apparatus need not partially exposed as opposed to the first embodiment, the configuration facilitates maintenance service of the apparatus.

### Third Embodiment

An image forming apparatus of a third embodiment includes the same skew removing mechanism as the first embodiment except that the skew sensors 216L and 216R of the second embodiment, a means for calculating the amount of skew from the outputs of the skew sensors 216L and 216R, and a means for displaying the calculated amount of skew are employed.

The amount of skew, K, of the print medium is calculated using equation (5).

K=(S2−S1)×V Eq. (5)

where S1 is the time at which the print medium passes the skew sensor 216L disposed at the left side of the transfer path, S2 is the time at which the leading edge of the print medium passes the skew sensor 216R disposed at the right side of the transport path, K is the amount of skew, and V is the speed at which the print medium is transported. Thus, the amount of skew K represents the positional deviation of the print medium relative to the skew sensors 216L and 216R in the direction of travel of the print medium. The amount of skew K is displayed on the panel of a display means (not shown). The graduation markings 101g of the skew removing mechanism 130b shown in FIG. 4 indicate a rotational position required for correcting positional deviations of the axes of the registry roller 131 and pressure roller 132.

If the left end of the leading edge of the print medium is ahead of the right end as shown in FIG. 21B, and the amount of skew K=3 is obtained, then the screw 103 is loosened to adjust the cam position by 3 markings in the negative direction. This causes the left ends of rotational axes of the registry roller 131 and pressure roller 132 of the skew removing mechanism 130b to move upstream by an amount equivalent to the amount of skew K. This corrects the amount of skew K.

As described above, even if the motor 260 of the second embodiment is difficult to be employed due to the limited installation location and availability of electric power, the amount of skew is detected, calculated, and displayed to the user. In addition, the inclination of the skew removing mechanism 3032 may be adjusted without the need for printing a skew adjusting print pattern as opposed to the first embodiment.

While the invention has been described with respect to a medium feeding apparatus for an additional medium feeding unit attached to an image forming apparatus, the invention may also be applied to image forming apparatuses and printers, copying machines and facsimile machines that include a medium transporting means.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is cleaimed is:

1. A medium feeding apparatus comprising:
a medium transporting mechanism that transports a medium;
a skew removing mechanism including a first roller and a second roller in pressure contact with the first roller;
an adjusting mechanism that adjusts a degree of rotational axes of the first and second rollers being right angle at a direction in which the medium should be transported by the medium transporting mechanism.

2. The medium feeding apparatus according to claim 1, wherein the medium transporting mechanism transports the medium on a page-by-page basis from a stack of medium held in a medium cassette.

3. The medium feeding apparatus according to claim 1, wherein the skew removing mechanism is mounted to a base frame (100) close to a transport path in which the medium is transported.

4. The medium feeding apparatus according to claim 3, wherein the skew removing mechanism includes a supporting member (101) by which the first roller and the second roller are rotatably supported.

5. The medium feeding apparatus according to claim 4, wherein the supporting member (101) is provided on the base frame (100) and is movable in a direction parallel to the direction in which the medium is transported.

6. The medium feeding apparatus according to claim 5, wherein the supporting member (101) is urged toward the base frame (101) by an urging member (104a, 104b) mounted to the base frame (100).

7. The medium feeding apparatus according to claim 6, wherein the supporting member (101) supports first longitudinal ends of the first roller (131) and the second roller (132).

8. The medium feeding apparatus according to claim 7, wherein the base frame (100) supports the second longitudinal ends of the first roller (131) and the second roller (132).

9. The medium feeding apparatus according to claim 8, wherein the adjusting mechanism includes a cam (102) rotatably mounted to the base frame (100), the cam (102) including a cam surface (102a) in contact with the supporting member (101, 101a), wherein when cam (102) rotates, the supporting member (101) is moved in a direction parallel to the direction in which the medium is transported.

10. The medium feeding apparatus according to claim 9, wherein the adjusting mechanism includes an indicator that indicates a rotational position of the cam.

15. The medium discharging mechanism according to claim 1, wherein said medium feeding apparatus is incorporated in an image forming apparatus.

16. The medium discharging mechanism according to claim 15, wherein the image forming apparatus prints a pattern that represents an amount of skew of the medium and the rotational position of the cam (102);
wherein the rotational position of the cam is determined from the pattern.

11. The medium discharging mechanism according to claim 10, wherein a detector (201L, 201R) is provided along the transport path, the detector outputting a detection output reflecting an amount of skew of the medium.

12. The medium discharging mechanism according to claim 11, further comprising a calculating section that calculates the amount of skew of the medium based on the detection output.

13. The medium discharging mechanism according to claim 12, further comprising a display section that displays the calculation result.

14. The medium discharging mechanism according to claim 11, wherein the detector is mounted in the vicinity of the skew removing mechanism.

17. The medium feeding apparatus according to claim 1 further comprising:
a detector disposed in a transport path in which the medium is transported, the detector detecting an amount of skew of the medium;
an information producing section that produces information on the amount of skew of the medium; and
a drive section that drives the adjusting mechanism;
wherein the adjusting mechanism determines the degree of rotational axes of the first and second rollers being right angle at the direction in which the medium is transported; and
wherein the drive section drives the adjusting mechanism in accordance with the degree.

18. An image forming apparatus that incorporates the medium feeding apparatus according to claim 17, wherein the image forming apparatus comprises:
an image forming section that forms a toner image on a photoconductive body;
a transfer section that transfers the toner image onto a print medium transported by the medium feeding apparatus; and
a fixing section that fuses the toner image on the medium.

19. The image forming apparatus according to claim 18, wherein the detector is disposed upstream of and in the vicinity of the image forming section.

20. The image forming apparatus according to claim 18, wherein the detector includes a plurality of optical sensors disposed in a direction parallel to a rotational axis of the photoconductive body.
